(19) United States
(12) Patent Application Publication
(10) Pub. No.: US 2025/0104016 A1
(43) Pub. Date: Mar. 27, 2025

(54) SYSTEM FOR THE CONTAINERIZATION OF BUSINESS WORKSTATIONS WITH LOW-COST REMOTE USER INTERFACES

(71) Applicant: Marco SIMONCINI, Fonte Nuova (RM) (IT)

(72) Inventor: Marco SIMONCINI, Fonte Nuova (RM) (IT)

(21) Appl. No.: 18/290,947

(22) PCT Filed: Jul. 18, 2022
(86) PCT No.: PCT/IB2022/056580

§ 371 Date: Jan. 22, 2024

(30) Foreign Application Priority Data
Aug. 4, 2021 (IT) 102021000021161

(51) Int. Cl. G06Q 10/101; G06Q 10/107

(52) U.S. Cl. CPC G06Q 10/101; G06Q 10/107

(57) ABSTRACT

Containerization system of business workstations with low-cost remote user interfaces, characterized in that it includes low-cost remote user interfaces, composed of a simple single-board computer and peripherals, suitable for connecting to remote virtual workstations in turn implemented by running, on a plurality of networked server computers, a containerization software suitable for running a Windows operating system with a graphical environment. The system also includes monitoring and direct communication functions between the containers of the same company.

### FIELD OF THE INVENTION

The present invention relates to the field of virtualization systems of computational resources, facing the challenges of compatibility with graphical applications used in numerous business areas.

### Prior Art

A physical or virtual machine, needing a kernel and a minimum pool of allocated resource, has a constant level of service based on the investment in terms of resources allocated to the machine. Solutions that allow you to work with a large number of operators involve a huge waste of resources connected to the necessary workstations or hypervisors; moreover, the risk of crashes, faults, downtime relating to the use of physical machines or virtual machines, especially when in use by the end user (operator), is always present and has a significant impact on productivity. For example, all standards relating to SLAs, Service Level Agreements, estimate a direct proportionality between the number of operators and the number of annual incidents that a facility will encounter. The time for resolving incidents constitutes a double cost for the structure: on the one hand the cost of a resolving intervention, on the other hand the stoppage of the operator. Containers are currently used purely in very complex infrastructures for the deployment of microservices, therefore most of these are operations that take place behind the scenes and therefore not aimed at end operators.

This solution represents a real innovation in the field of IT management of any production activity that involves the use of many terminals. Thanks to the use of container technology, bent by the inventor to the creation of self-consistent pods, totally ephemeral in file management, reachable from any device and with any operating system even from remote offices through implementation within the cluster (physical nodes) of Open VPN terminals internal or external to the cluster, it will be possible for any organization to reduce the costs of workstations and/or servers, the costs associated with managing internal IT and delivery times relating to workstations and servers.

There is no lack of previous works, such as patent US2021019169A1 where a kernel extension is presented as a means to efficiently containerize applications. However, no solution is specified for the Windows operating system, nor is a methodology presented to effectively leverage the capabilities of containers to build a graphical remote access application. Finally, no reference is made to methodologies to make the experience of an operator in the company economically efficient with the need for access to computationally demanding applications. There is no doubt, therefore, that these solutions only partially address the critical issues set out so far.

### DESCRIPTION OF THE INVENTION

According to the present invention, a containerization system of business workstations with low-cost remote user interfaces is implemented, which allows an optimal organization and distribution of the often complex and computationally intensive workflows to the operators working in the scope, making the most of hardware resources in the Cloud environment. At present, any computing machine (client or server) can be conceived, be it physical or virtual, only if provided with its own kernel. By Kernel we mean the software layer for managing and connecting software and hardware that performs the various management functions, such as that of resources, intervals, processes and all peripherals. Any computing machine supports a set of services necessary for its operation and the operations for which the machine is designed. Regardless of the size of the resources assigned to it, which varies according to need, the individual physical or virtual machine needs a set of its own and defined resources without which it could not function. It follows that the current IT infrastructures, from the simplest to the most complex, may be composed of physical machines, virtual machines or a combination of the two, all provided with their own kernel and a pool of resources assigned to them. Since 2014, container technology has been introduced in the world of computing. To better understand the usefulness of the present invention it is necessary to explain the concept of “container”. A container is an abstract unit of software that is independent and executable, as it has everything necessary to run an application, such as: a code, Runtime, tools and system libraries. Containers have defined parameters and can run a specific program, workload, or task. A simple analogy for understanding digital containers is to think about shipping physical containers. One can load a lot of goods in a single container and one can load many containers on a single ship or split them over multiple ships. Specialized containers may also be used for specific workloads, in the same way as a refrigerated container may be used to transport a specific type of cargo. The only limitation with containers is that they depend on their host system “kernel”. A Linux container, for example, may only run on a Linux host, a Windows container runs on a Windows host, and so on for other operating systems. Containers allow system administrators to achieve greater density with their architecture. One can define and execute multiple containers, each customized for a specific workload for greater efficiency. Containers have only the necessary, so as not to be full of superfluous software and not to waste computing resources on background processes. Businesses are discovering the enormous usefulness of containers, as they are portable, consistent and easy to use. IT departments can enable seamless integration and delivery with the agility and automation that containers provide, and they also help isolate workloads, contributing to robust data security policies. Virtual machines are also independent computing environments, abstracted from hardware, but unlike containers they require a complete replica of an operating system in order to function. An advantage of virtual machines is that they can be used to simulate an operating system other than the host system: if the host machine is running Windows, one can run a Linux operating system in a virtual machine and vice versa, plus virtual machines allow for greater isolation and data security, as computing systems are even more isolated. However, since the latter are essentially independent systems with their own operating system, they require much longer boot times than containers and are consequently less efficient. Containers, on the other hand, have the advantage of being more portable, since a complex workload can be spread across multiple containers, which can be distributed anywhere in various systems or cloud infrastructures. For example, one can deploy workloads across multiple containers across on-premise hardware and public cloud service, managing everything through a single orchestration dashboard. Because of this portability, containers scale more effectively than virtual machines. The concept of container travels hand in hand with the use of “Container Orchestrations” such as Docker and Kubernetes. These tools allow the management of containers, the distribution of services on multiple physical servers and the creation of clusters dedicated to the deployment of containers. Orchestration is a methodology for providing a bird's-eye view of containers, providing visibility and control where containers are deployed and how workloads are allocated across multiple containers. Orchestration is essential for implementing multiple containers. Without orchestration, you need to manually manage each individual container. One of the improved features thanks to container orchestration is the ability to automatically manage workloads across multiple compute nodes, the term “nodes” refers to any system connected to a network, for example, if there are five server, but one server initiates a maintenance cycle, the orchestration can automatically divert the workload to the remaining four servers and balance it based on what the remaining nodes can handle. The orchestration can perform this activity without human assistance. As we have seen, it is possible to use containers to perform a specific task, program or workload, such as a microservice, which is a specific function of a larger service or application. For example, one can use a container to perform a search or search function on a dataset, rather than loading an entire database application. Since the operation works within a container environment, it runs faster than a non-container type environment, be it a virtual machine or bare metal, with a full operating system and backup processes that take up additional computing resources, in this way containers make it easier and faster to deploy and use microservices. Furthermore, within a hybrid cloud environment, the container becomes the computing unit, abstracted from the underlying hardware. It is not necessary to worry about where the containers will run, as one can run them anywhere. Containers therefore make it easier to deploy workloads in a hybrid cloud environment. This is typically handled through the orchestration platform, so administrators have visibility into where containers are deployed and what functionality each node offers, across public cloud infrastructures and on-premises. The object of the present invention is to make containers an entity usable by any operator who is at a terminal by exploiting all the advantages in terms of reliability and performance that characterize this technology. Basically, the use of container technology is allowed to create workstations from a centralized hardware infrastructure, minimizing the resources needed by the single workstation. This patent provides for the presence of a series of remote user interfaces, which are each made up of an inexpensive single-board computer, connected in turn to various input-output peripherals, the type and number of which varies according to the needs of the operator. These single-board computers have been designed to optimize, for example, the graphic rendering, that is the process of generating an image starting from a mathematical description of a three-dimensional scene, interpreted by algorithms that define the color of each point of the digital image, on multiple screens and for a wide bandwidth. At the same time, these single-board computers have minimal RAM resources and a processor with an architecture, reduced to the bare minimum, for displaying data and communicating with the containerization system created by the present patent, thus being more cost-effective and simple. The invention also includes a set of computer servers connected to the network and with a container orchestration installed which allows to manage the organization and distribution of application containers containing the desktop applications used by the operators connected through the aforementioned remote user interfaces. These containers are created with a containerization software that allows running in an isolated and independent manner a Windows operating system with remote graphical access capabilities, on a host container with Unix-based operating system, thus respecting the specifications of the OCI-Open Container Initiative, which promotes the standardization of container technologies, and now under the umbrella of the Linux Foundation has released version 1.0 of its runtime for defining the lifecycle and specifications of the images that containerized software will need to have. All this is made possible thanks to the level of customization possible in the open-source KubeVirt software which, after an in-depth study, has been customized and integrated with drivers and emulators such as, by way of example but not limited to, QEMU, to allow for the level of integration. between hardware and software described herein and below. For further details of configuration and implementation, please refer to the experimental and software documentation mentioned.

We now want to reiterate how much being able to deal with user interface sessions through container abstraction allows for a much more effective, faster, simpler and more accurate level of automatic scalability than that which can be obtained using classic virtual machines. It is therefore clear that the research carried out and the innovations introduced here unlock important technical possibilities in the management of remote applications.

Finally, even if not already subject to experimentation, it is proposed to use the same principles, whose feasibility has been tested with Windows on Unix operating systems, can be applied to a collection of other operating systems that can be run, in a containerized manner, on any other native operating system of the machine.

This system, therefore, includes a series of specialized containers that guarantee a high level of availability of applications to operators, among the different containers there is a specific container with the monitoring function, which allows the recovery of unused resources, and a customized network communication protocol that allows communication between distributed Windows applications like a local LAN, Local Area Network, which corresponds to a connection of devices within a specific area, where each device is defined as a node of the network and is connected to the server, even if there is no clear maximum limit to what can be considered a LAN, this network typically covers a small area, such as a single office, building, or a few buildings within an area. This system also proposes to elaborate, through the containerization software, specific containers dedicated to tasks without interaction with the user, such as containers that deal with both load balancing, or that have the task of distribute the processing load of a specific service, for example the provision of a website (in this case it takes the more specific name of Network Load Balancing), among multiple servers, thus increasing the scalability and reliability of the architecture as a whole, and containers that aim at the perimeter defense of the network with firewall software. Clouds and mobile technologies have made any security strategy based on defending the company's physical perimeter obsolete. To resist increasingly sophisticated and targeted cyber-attacks, a new line of defense based on digital identity and access management must be implemented, such as IAM, Identity and Access Management and two-factor authentication, which are also managed by specific and independent containers. All of the aforementioned containers are connected to a shared distributed file system with access controlled by an authorization system. This distributed file system is stored on a redundant shared storage system, according to known redundancy protocols, and therefore, accessible to all application containers. To better manage the distribution of containers, this system is provided with a control panel consisting of a touchscreen, connected to the network and provided with an interactive software that is able to show the monitoring data, detected by the specific monitoring container, to the infrastructure administrator. This containerization system allows for a highly efficient and fast communication system that enables a video calls, file exchange, and messages between company employees and between employees and external collaborators. These exchanges are immediate as they are based precisely on the fast connection of the containers that act as a backend for the operators' desktop applications, in fact they are physically located close to the operators and are also enabled for a fast streaming of information for a better user experience than any external provider. To guarantee and further raise the level of security of company data, the present invention provides for the presence of a hardware resource partitioning system which has the task of making the resources entrusted to external collaborators isolated at the hardware level. This isolation guarantees a high level of cyber-security, such as to make cyber-attacks on the containerization software created in this patent ineffective, in fact the various containers are expected to run on physically different machines. A further degree of security is guaranteed by the presence of a peripheral connected to the single-board computer which has the function of hardware authentication, that is, it guarantees secure access to sensitive files present in the system. Secure access can take place thanks to the fact that this device can only be activated via a hardware token, contained in the company badge. The token is a generator of pseudorandom numerical codes at regular intervals (in the order of a few tens of seconds) according to an algorithm that, among other factors, takes into account the passage of time thanks to an internal clock, this code, random and transitory, is combined with a PIN known to the user and the authentication system to generate a temporary password which can be used to authenticate within the time interval.

The advantages offered by the present invention are clear in the light of the above description and will be even clearer from the accompanying figures and the related detailed description.

### DESCRIPTION OF THE FIGURES

The invention will hereinafter be described in at least a preferred embodiment thereof by way of non-limiting example with the aid of the accompanying figures, in which:

FIG. 1 shows the main elements constituting said containerization system of business workstations with low-cost remote user interfaces, which comprises a plurality of remote user interfaces 100 characterized in turn by low-cost single-board computers 101 connected to a plurality of input-output peripherals 102. In particular, the system comprises a peripheral for hardware authentication 600 connected to said single-board computer 101 which can be activated by means of a hardware token 601 contained in the company badge and adapted to guarantee secure access to sensitive files present in the system. The invention is further characterized by a plurality of server computers 103 which are connected in a network 104 and which have installed a container orchestration 105 suitable to manage the life cycle of a plurality of application containers 106 containing the desktop applications to be served to the operators connected through said remote user interfaces. In order to recover unused resources, between said application containers there is a specialized container with monitoring function 109 connected to a control panel consisting of a further touchscreen panel 300 connected to said network 104, which through the use of interactive software shows the detected monitoring data. In addition, there are additional specialized containers dedicated to tasks without user interaction, created through a containerization software 107 which allows running in isolated mode a Windows operating system with remote graphical access capabilities, and dedicated to: load balancing 201, firewall 202, IAM 203, and two-factor authentication 204. Said containers are connected to a shared distributed file system 205 with accesses controlled by an authorization system accessible to all application containers and stored on a redundant shared storage system 206. Finally, the figure shows a customized network communication protocol 110 adapted to allow communication between distributed Windows applications.

FIG. 2 instead illustrates some modules integrating said business workstation containerization system. In particular, the present invention in order to guarantee an efficient interaction service is characterized by a communication system 400 suitable for enabling video calls, file exchange, and messages between company employees and between employees and external collaborators. The invention also comprises a hardware resource partitioning system 500 suitable for making the resources entrusted to external collaborators isolated at the hardware level, and for guaranteeing computer security of the system. Finally, the figure shows the optimization of said single-board computers 101 implemented for graphic rendering on multiple screens and for a large bandwidth including minimal resources of RAM and processor 700 with architecture reduced to the bare minimum.

### DETAILED DESCRIPTION OF THE INVENTION

The present invention will now be described purely by way of non-limiting or binding example with the aid of the figures, which illustrate some embodiments relative to the present inventive concept.

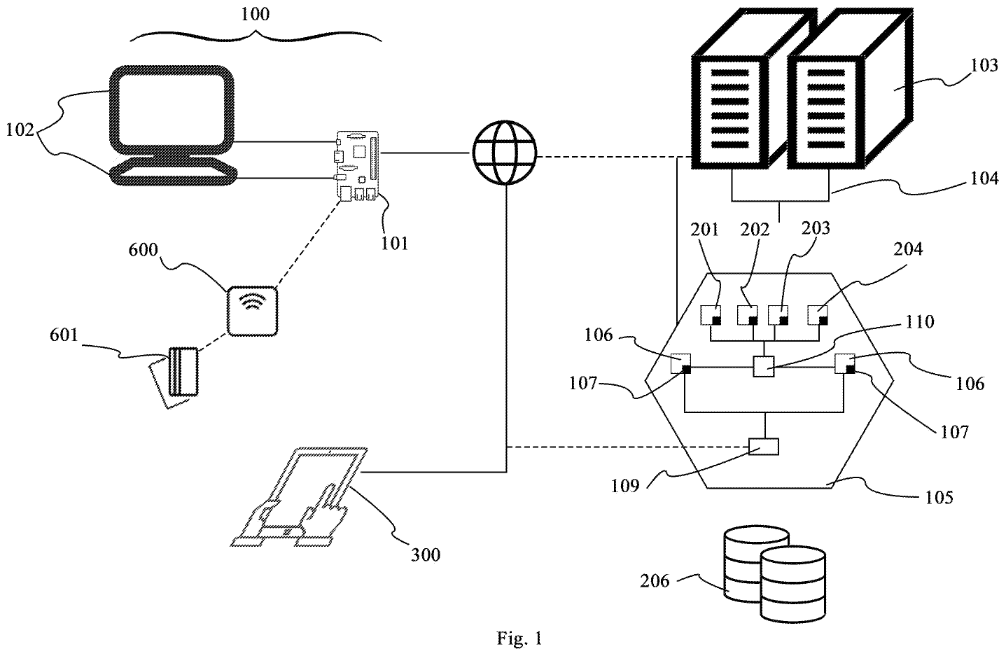

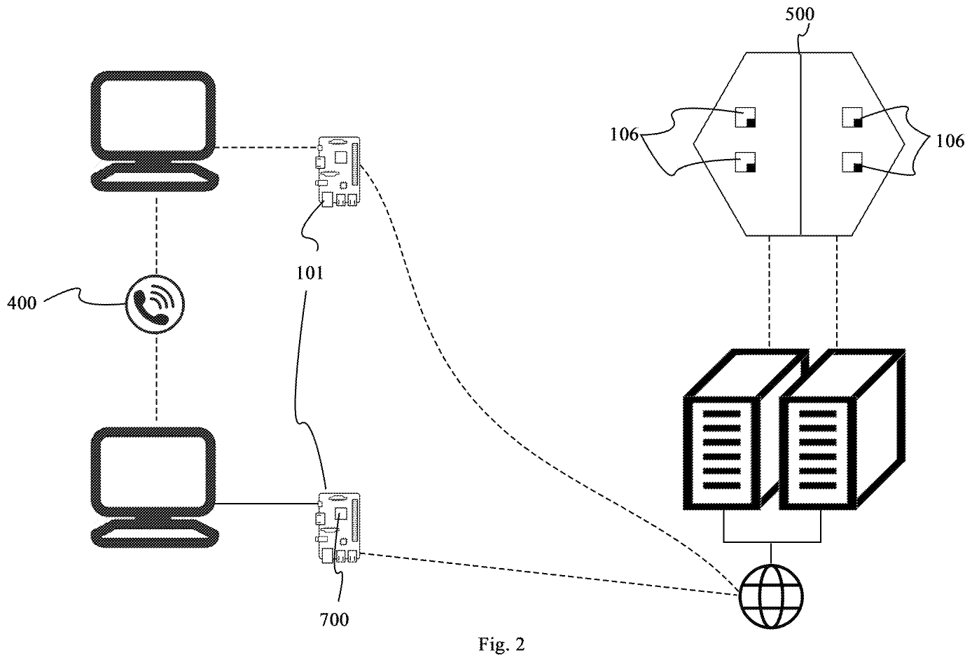

With reference to FIG. 1, it illustrates the main components of the present invention suitable for allowing complex and computationally intense workflows to a plurality of operators through the optimal use of hardware resources in a Cloud environment. In order to do so, the system provides: a plurality of remote user interfaces 100 in turn characterized by single-board computers 101 connected to a plurality of input-output peripherals 102 depending on the needs of the operator. In particular, said single-board computers 101 are connected to a specialized hardware authentication device 600 which can be activated by means of a hardware token 601 contained in the company badge and adapted to guarantee secure access to sensitive files present in the system. The figure also illustrates a plurality of computer servers 103 connected to a network 104 and on which a container orchestration 105 is installed, suitable for managing the life cycle of one and a plurality of application containers 106 which contain the desktop applications to be served to operators connected through said remote user interfaces and adapted to act as a backend for the operators' desktop applications, said containers are in fact physically located close and enabled for a fast streaming of information to ensure a better user experience than any external provider. In particular, said system provides, between said application containers, a specialized container with a monitoring function 109 suitable for recovering unused resources and connected to a control panel consisting of a further touchscreen panel 300 connected to said network 104, which through the use of an interactive software shows the monitoring data detected by said container with monitoring function to the infrastructure administrator. The system includes additional specialized integrating containers dedicated to tasks without user interaction that have been created using containerization software 107 capable of running in isolated mode, thus respecting the OCI specifications, a Windows operating system with remote graphical access capabilities, and in particular are dedicated to various objectives such as: load balancing 201, firewall 202, IAM 203 and two-factor authentication 204. In particular, said containers are connected to a shared distributed file system 205 with accesses controlled by an authorization system accessible to all application containers and stored on a redundant shared storage system 206 according to known redundancy protocols. Finally, the image illustrates a customized network communication protocol 110 adapted to allow interaction between distributed Windows applications like a local LAN network. As regards FIG. 2, on the other hand, it represents the integrative components of said containerization system of business workstations with low-cost remote user interfaces. The invention, in fact, provides for a communication system capable of enabling video calls, file exchange, and messages between company employees and between employees and external collaborators, these exchanges are immediate as they are based on the possibility of exploiting the fast connection between said containers 106. In order to implement the information security of said system, the invention is characterized by a hardware resource partitioning system 500 suitable for making the resources entrusted to external collaborators isolated at the hardware level, and for guaranteeing computer security of the system. Said isolation allows, in fact, to guarantee a higher level of cyber security, making possible attacks on the containerization software ineffective as the containers in execution are placed on physically different machines. Finally, FIG. 2 shows how said single-board computers 101 are implemented for graphical rendering on multiple screens and for a wide bandwidth comprising minimum RAM and processor resources 700 with the minimum architecture indispensable for displaying the data in communication with said containerization system, and therefore more cost-effective and simpler to construct.

Finally, it is clear that modifications, additions or variants may be made to the invention described thus far which are apparent to those skilled in the art, without departing from the scope of protection that is provided by the appended claims.

1. System for the containerization of business workstations with low-cost remote user interfaces, wherein the system allows complex and computationally intensive workflows to a plurality of operators, with an optimal use of hardware resources in a Cloud environment; said system comprising:
A) a plurality of remote user interfaces in turn comprising: a cost-effective single-board computer connected to a plurality of input-output peripherals depending on the needs of the operator;
B) a plurality of server computers connected in a network and having installed a container orchestration suitable to manage the life cycle of a plurality of application containers containing the desktop applications to be served to the operators connected through said remote user interfaces;
C) said containers being created with a containerization software that allows to run in isolated mode, therefore complying with the OCI specifications, a Windows operating system with graphical remote access capacity, on a host container with Unix-based operating system;
said system therefore comprising specialized containers suitable to guarantee a high level of availability of the applications toward the operators, in and a customized network communication protocol suitable to allow communication between Windows applications distributed equal to a local area network LAN.

2. The system for the containerization of business workstations with low-cost remote user interfaces, according claim 1, further comprising containers dedicated to tasks without interaction with the user, created with said containerization software and dedicated to: load balancing, firewall, IAM, two-factor authentication; said containers being also connected to a distributed file system shared with accesses controlled by an authorization system, said distributed file system, accessible to all the application containers, being stored on a redundant shared storage system, according to known redundancy protocols.

3. The system for the containerization of business workstations with low-cost remote user interfaces, according to claim 1, further comprising a control panel consisting of a touchscreen panel, connected to said network, provided with an interactive software suitable to show the monitoring data detected by said container with monitoring function to the infrastructure administrator.

4. The system for the containerization of business workstations with low-cost remote user interfaces, according to claim 1, further comprising a communication system suitable to enable video calls, file exchange, and messages between employees of the company and between employees and external collaborators; said exchanges being immediate given that they are based on the possibility of exploiting the fast connection between said containers, suitable to act as backend for the desktop applications of the operators, said containers being physically positioned close to each other and enabled to carry out a fast streaming of information for a better user experience with respect to any external provider.

5. The system for the containerization of business workstations with low-cost remote user interfaces, according to claim 1, further comprising a system for partitioning hardware resources suitable to isolate, at hardware level, the resources entrusted to external collaborators, said isolation suitable to guarantee a higher level of cyber security and render attacks against the containerization software developed in the present invention ineffective, the containers running on physically different machines.

6. The system for the containerization of business workstations with low-cost remote user interfaces, according to claim 1, further comprising a hardware authentication device connected to said single-board computers suitable to ensure secure access to sensitive files present in the system; said device being suitable to be activated by means of hardware token contained in the company badge.

7. The system for the containerization of business workstations with low-cost remote user interfaces, according to claim 1, wherein said single-board computers are optimized for graphical rendering on multiple screens and for a wide bandwidth and at the same time comprising minimum RAM and processor resources with the minimum architecture indispensable for displaying the data in communication with said containerization system, and therefore more cost-effective and simpler to construct.

8. The system for the containerization of business workstations with low-cost remote user interfaces, according to claim 1, wherein being created with a containerization software, said containers are generalized to pairs of any host-guest operating systems.

9. The system of claim 1, wherein the specialized containers comprise at least one container with monitoring function suitable to recover the unused resources.

10. The system for the containerization of business workstations with low-cost remote user interfaces, according to claim 2, further comprising a control panel consisting of a touch-screen panel, connected to said network, provided with an interactive software suitable to show the monitoring data detected by said container with monitoring function to the infrastructure administrator.

11. The system for the containerization of business workstations with low-cost remote user interfaces, according to claim 10, further comprising a communication system suitable to enable video calls, file exchange, and messages between employees of the company and between employees and external collaborators; said exchanges being immediate given that they are based on the possibility of exploiting the fast connection between said containers, suitable to act as backend for the desktop applications of the operators, said containers being physically positioned close to each other and enabled to carry out a fast streaming of information for a better user experience with respect to any external provider.

12. The system for the containerization of business workstations with low-cost remote user interfaces, according to claim 11, further comprising a system for partitioning hardware resources suitable to isolate, at hardware level, the resources entrusted to external collaborators, said isolation suitable to guarantee a higher level of cyber security and render attacks against the containerization software developed in the present invention ineffective, the containers running on physically different machines.

13. The system for the containerization of business workstations with low-cost remote user interfaces, according to claim 12, further comprising a hardware authentication device connected to said single-board computers suitable to ensure secure access to sensitive files present in the system; said device being suitable to be activated by means of hardware token contained in the company badge.

14. The system for the containerization of business workstations with low-cost remote user interfaces, according to claim 13, wherein said single-board computers are optimized for graphical rendering on multiple screens and for a wide bandwidth and at the same time comprising minimum RAM and processor resources with the minimum architecture indispensable for displaying the data in communication with said containerization system, and therefore more cost-effective and simpler to construct.

15. The system for the containerization of business workstations with low-cost remote user interfaces, according to claim 14, wherein being created with a containerization software, said containers are generalized to pairs of any host-guest operating systems.
